(19) United States
(12) Patent Application Publication
(10) Pub. No.: US 2014/0030387 A1
(43) Pub. Date: Jan. 30, 2014

(54) MICRO-ENCAPSULATED ANIMAL PROTEIN CONCENTRATE

(71) Applicant: Map Chile SpA, Santiago (CL)

(72) Inventors: Cristian Cifuentes Larios, Santiago (CL); Simón Salosny Hübner, Santiago (CL)

(21) Appl. No.: 13/948,368

(22) Filed: Jul. 23, 2013

(30) Foreign Application Priority Data
Jul. 24, 2012 (CL) 2056-2012

(51) Int. Cl. A23J 1/04; A23J 3/00

(52) U.S. Cl. CPC A23J 1/04; A23J 3/04
USPC 426/92; 426/552; 426/646; 426/574; 426/293

(57) ABSTRACT

The invention relates to an animal protein concentrate, fit for the human consumption, elaborated on basis of a fish protein. More specifically, this invention relates with micro-particle matrix or multicore of fish protein and gelatin, optionally coated, fit for the elaboration of processed food for human consumption.

### CROSS-REFERENCE TO RELATED APPLICATIONS

This patent application claims the benefit of Chilean Patent Application No. 2056-2012, filed Jul. 24, 2012, which is incorporated by reference.

### BACKGROUND OF THE INVENTION

Fish proteins, such as fishmeal, are low in cost and contain high levels of nutrients compared to other animal proteins. However, previous attempts to incorporate fish proteins into food products have been met with mixed results. Although fishmeal is highly nutritive, it is generally only used in animal feed since existing processes do not eliminate the fish flavor and odor, and food products that retain a fish flavor and odor are undesirable for human consumption.

JP 11302158 relates to a method for producing a gelatin capsule containing vegetable oils and Lactobacillus.

JP 2000125801 relates to a particle matrix composed of a dried, fermented, and granulated fish meat with a polysaccharide polymer coating.

WO/2004/043140 relates to a product and a method of preparing a dry and wet particle to feed aquatic animals, composed of an indigestible matrix that may contain fish protein in addition to other bioactive agents. The method describes an amorphous particle, but does not describe flavor or odor masking.

WO/2005/115341 describes a polymeric matrix comprising indigestible and digestible elements, including fishmeal, for the purpose of administering medications to a wide range of animals.

In fishmeal formulations, it is common the use to ethoxyquin as an antioxidant, as it stabilizes fats, protects nutritive value, and prevents oxidative degradation of fats, oils, and other compounds such as vitamins and pigments. However, ethoxyquin is only authorized for use in pet foods.

In summary, the prior art describes food products with high fish protein content, but none has proved suitable for human consumption.

### BRIEF SUMMARY OF THE INVENTION

The invention provides a microencapsulated animal protein (MAP) particle comprising animal protein and gelatin, wherein the MAP particle is suitable for human consumption. The invention further provides food products containing the MAP and methods of making the MAP. In a preferred embodiment, the MAP comprises animal protein concentrate (APC) in a gelatin matrix, coated with zein.

### BRIEF DESCRIPTION OF THE DRAWINGS

FIG. 1A is an electron microscopy image of ground (e.g., milled) APC ground.

FIG. 1B is an electron microscopy image of the surface of APC particles.

FIG. 2 is a schematic representation of a multi-core particle, including APC particles encapsulated in gelatin and optionally coated with zein.

FIG. 3A is a set of electron microscopy images of gelatin-coated MAP particles at 100× magnification (left) and 1000× magnification (right). FIG. 3B is a graph showing a distribution of MAP by particle size, evaluated by laser dispersion.

FIG. 4A is a set of electron microscopy images of zein-coated MAP/z particles at 100× magnification (left) and 1000× magnification (right). FIG. 4B is a graph showing a distribution of MAP/z by particle size, evaluated by laser dispersion.

### DETAILED DESCRIPTION OF THE INVENTION

The invention provides a microencapsulated animal protein (MAP) particle comprising animal protein and gelatin, wherein the MAP particle is suitable for human consumption. “Suitable for human consumption,” as used herein, refers to a MAP particle that does not have a fishy taste or odor, or a MAP particle that does not notably change the taste, odor, texture, or appearance of a food product containing the MAP particle.

The animal protein may be any animal protein, but is preferably animal protein concentrate (APC) comprising fish protein, such as fishmeal. For example, the APC may contain at least 30 wt % animal protein, up to about 10 wt % fat, about 10 wt % water, and about 14% ash. The APC may be derived from any fish species, including anchovy (Engraulis ringens), sardine (Sardinops sagax), horse mackerel (Trachurus murphyi) and mackerel (Scomber japonicus).

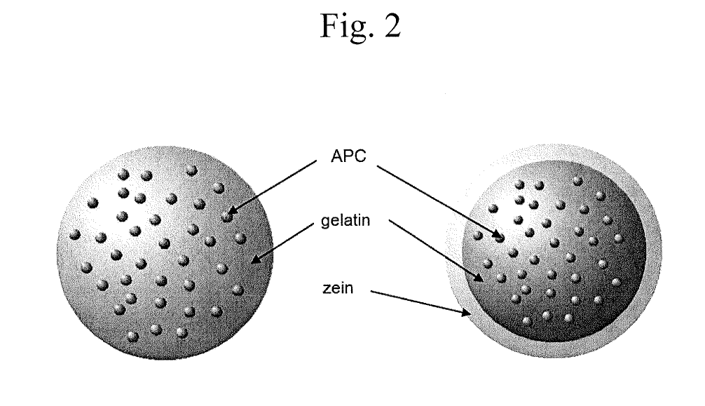

In a preferred embodiment, the MAP particle comprises APC particles encapsulated in a gelatin matrix. The MAP particle may optionally be coated with a protein material, preferably zein or a zein derivative. FIG. 2 is a schematic representation of a multi-core MAP particle comprising APC particles encapsulated in gelatin and optionally coated with zein. The coating may comprise at least about 5 wt % of the total weight of the MAP particle, preferably between 30 wt % and 60 wt %.

The size and shape of APC particles is important for obtaining the desired organoleptic properties (i.e., a lack of fishy taste or odor). The APC particles may be spherical or irregularly shaped, and may be formed using any microencapsulation technique. In one embodiment, the APC particle is formed using mill, e.g., a ball mill. Milling may be used to form APC particles with a particular size and shape, or within a measured distribution size range. Preferably, the APC particles are less than about 500 μm in diameter, or, even more preferably, less than about 200 μm in diameter. Particularly preferred are APC particles about 1 μm to about 200 μm in diameter. It is also preferred that the APC particle size distribution is relatively narrow. For example, at least 60% of the APC particles may have a diameter between about 5 μm and about 100 μm.

Preferably, the MAP particle is less than about 1,000 μm in diameter, e.g., about 200 μm in diameter. In one embodiment, the MAP particle is about 100 μm to about 1,000 μm in diameter. It is also preferred that the MAP particle size distribution is relatively narrow. For example, at least 60% of the APC particles may have a diameter between about 200 μm and about 600 μm.

Once the animal protein concentrate is processed, it may be treated with one or more antioxidants, such that the APC particles further comprise an antioxidant. Preferably, the antioxidant is EDTA, a tocopherol, sodium ascorbate, L-ascorbic acid, BHA, BHT, lactic acid, citric acid, tartaric acid, and a phosphate.

The antioxidant may be a tocopherol. For example, the tocopherol is applied at a ratio of 1,000 ppm on flour. The antioxidant is heated at a temperature of 45° C. indirectly to reach the antioxidant homogenization. Subsequently, the tocopherol is applied by direct addition (aspertion) to the raw fishmeal, with a spray nozzle to a fishmeal mixing screw, homogenizing the final product and is bagged.

The antioxidant may be EDTA. For example, the procedure may be started with the preparation of an EDTA solution at 0.5% p/v. Then, 5.0 gr of solid EDTA may be weighed and diluted in 1,000 ml of distilled water to obtain the raw material (i.e., fishmeal) coating. 1,000 g of raw material may be immersed in the in 0.5% p/v EDTA solution for 5 minutes, and then drained.

Optionally, the animal protein may also be treated with other antioxidants such as sodium ascorbate, L-ascorbic Acid, BHA, BHT, lactic acid, citric acid, tartaric acid, and phosphates.

Aside from gelatin and zein, the MAP may further comprise one or more of a wax, an oil, a polymer, a polysiloxane, an additive, a colorant, a flavoring, a preservant, a flavor enhancer, an aromatic subtance, and a sweetener.

The colorant may be a natural or synthetic colorant, including tartarazine E102, quinoline yellow E1 04, sunset yellow E110, blue patent V E131, Cochineal red E-120, bright blue E133, green S E142, rapid green FCF E143, caramel E150, azorubine or carminosine E122, cochineal red A E124, allura red AC E129, curcumin E-100, riboflavin E-101 chlorofill E-141, iron oxid E172, etc., and combinations thereof.

The sweetener may be a natural or synthetic sweetener, including sucralose E955, aspartame E951 and saccharine E954, etc., and combinations thereof.

The flavor enhancer may be a natural or synthetic flavor enhancer, including monosodium glutamate E621, disodium inosinate E631, glutamic acid E620, mono-potassium glutamate E622, calcium diglutamate E623, ammonium glutamate E624, magnesium diglutamate E625, guanylic acid E626, disodium guanylate E627, dipotasium guanylate E628, calcium guanylate E629, E630 inosinic acid, dipotassium inosate E632, calcium inosinate E633, 5′-calcium ribonucleotides E634, 5′-sodium ribonucleotides E635, maltol E636, ethylmaltol E637, glycine and sodium salt E640, L-leucine E641, dimethylpolysiloxan E900, etc., and combinations thereof.

The flavoring may be a natural or synthetic flavouring, including vanilla, caramel, pineapple, chocolate, cheese, garlic, onion, citric acid, sodium malate, triethly citrate, etc., and combinations thereof.

The MAP particle may further comprise additives, such as antioxidants, preservants, stabilizers, and combinations thereof, or other coatings such as bee wax, polyunsaturated vegetal oils such as canola oil, polysiloxanes, and edible silicones.

The invention also provides a food product comprising the MAP particle. The food product may be any food product for human consumption, including sweet or salted food products including meat products such as sausage, ground meat, hamburger, or nuggets; soup; dairy products such as yogurt, pudding, cream, cheese, or ice cream; fruit juice;

chocolate-based products such as chocolates bars; cereal bars; energy bars; cereals; flour-based products such as biscuits or bread; jams; sauces or condiments such as mayonnaise, ketchup, and tartar sauce; condiments; and food supplements. The food supplements may be, for example, high protein supplements for adults, children, athletes, elderly people, or undernourished people.

The MAP particles preferably dissolve in the post-pyloric gastrointestinal system, so that no fish flavor or odor fish odor is detected during consumption of a food product containing a MAP particle. Moreover, the MAP particles do not dissolve in water at room temperature or higher temperatures, such as cooking or baking temperatures.

The invention further provides a method of making the MAP particle. For example, the MAP particle may be formed using spinning disc overcoating (rotating disc), fluid bed coating, and/or centrifugal co-extrusion. Additionally, a zein coating may be applied using, for example, fluid bed coating.

The following examples further illustrate the invention but, of course, should not be construed as in any way limiting its scope.

### EXAMPLE 1

This example demonstrates the processing of APC particles.

The initial raw material is animal protein, preferably fish protein, processed by standard fishmeal processing methods. During processing or later, optionally, an antioxidant or a combination thereof is applied.

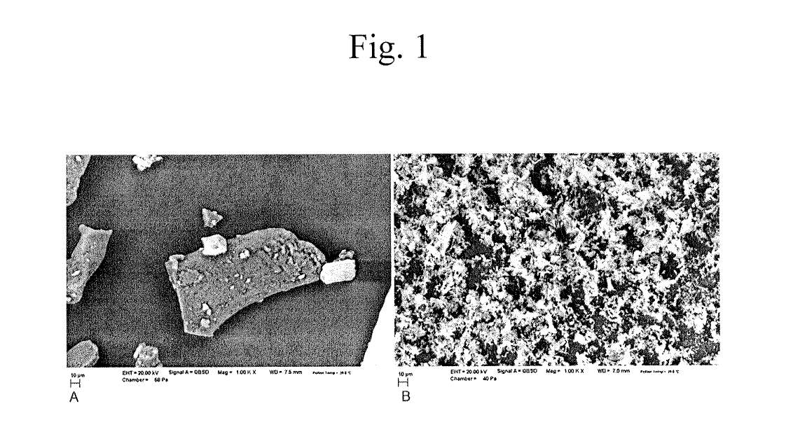

Once the fishmeal is obtained, it is processed by grinding using a ball mill into a particle size in the 1-200 μm range (FIG. 1).

### EXAMPLE 2

This example demonstrates the generation of MAP particles comprising gelatin using spinning disk encapsulation.

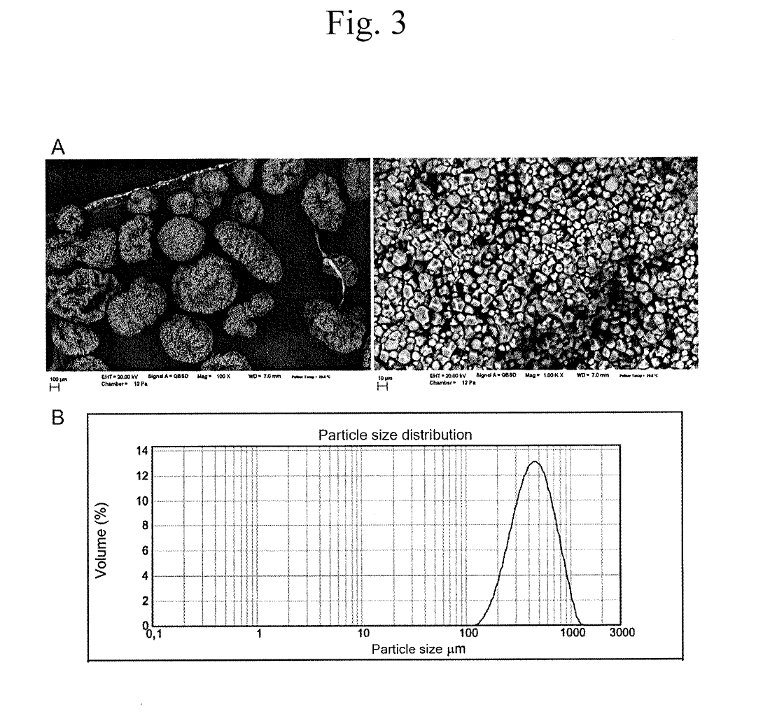

17.8 g of sodium ascorbate was added to 8.09 kg of APC in suspension at 22% w/w. This mixture was homogenized with 4.80 kg gelatin at 20% w/w in solution at 60-65° C. The suspension was poured on a spinning disk at 3,000 rpm. The solution was atomized in a chamber at room temperature. The solidified drops were collected on a micronized starch bed. The particles were left to dry for 4 to 24 hours, depending of the room humidity of the atomization room (FIG. 3).

### EXAMPLE 3

This example demonstrates the generation of MAP particles coated with zein using fluid bed coating.

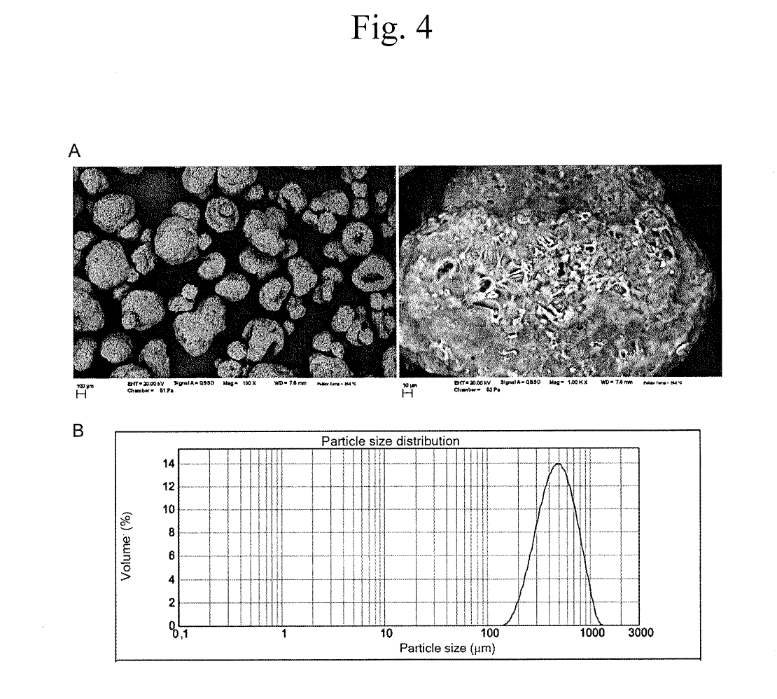

The fluid bed was loaded with 1.5 kg of MAP prepared according to Example 2. The inlet temperature was set at 60° C. with a product temperature of 40° C. and an outlet temperature of 35.9° C. The air flow input was set at 15 scfm. The atomization air pressure was set approximately at 6 psig and the filter pressure was approximately about 85 psig. The spray solution consisted of a mixture 90:10 of ethanol and water with 10% p/p of zein and 0.01% w/w of Tween 80. The spray solution was applied until the weight of the final product was 1.72 kg, representing a coating of 12.79% w/w (FIG. 4). This product was named MAP/z.

### EXAMPLE 4

This example demonstrates the preparation of a baked food product, such as cake, using MAP particles.

| Ingredients | Formula 1 | | Formula 2 | | Formula 3 | |
|---|---|---|---|---|---|---|
| Margarine | 125 | g | 80 | g | 100 | g |
| Sugar | 350 | g | 350 | g | 350 | g |
| Eggs | 2 | u | 2 | u | 2 | u |
| Milk | 320 | mL | 320 | mL | 320 | mL |
| Lemon zest | 1 | u | 1 | u | 1 | u |
| Vanilla essence | 40 | g | 40 | g | 40 | g |
| MAP | 50 | g | 100 | g | 0 | g |
| Flour | 320 | g | 320 | g | 320 | g |
| Baking powder | 12 | g | 12 | g | 12 | g |

The oven is preheated to 200° C. Sugar and margarine are added in a bowl, then two beaten yolks, milk, and strained flour are mixed with MAP. Then lemon zest and the vanilla essence are added. Separately, in a bowl, 2 egg whites are beaten until stiff and are softly incorporated into the mixture. Lastly, baking powder is added. The mixture is left to rest for 5 minutes and baked for 45 to 60 minutes at 140° C.

### EXAMPLE 5

This example demonstrates the preparation of a baked food product, such as cake, using MAP/z particles.

| Ingredients | Formula 1 | | Formula 2 | | Formula 3 | |
|---|---|---|---|---|---|---|
| Margarine | 125 | g | 80 | g | 100 | g |
| Sugar | 350 | g | 350 | g | 350 | g |
| Eggs | 2 | u | 2 | u | 2 | u |
| Milk | 320 | mL | 320 | mL | 320 | mL |
| Lemon zest | 1 | u | 1 | u | 1 | u |
| Vanilla essence | 40 | g | 40 | g | 40 | g |
| MAP/z | 50 | g | 100 | g | 0 | g |
| Flour | 320 | g | 320 | g | 320 | g |
| Baking powder | 12 | g | 12 | g | 12 | g |

The oven is preheated to 200° C. Sugar and margarine are added in a bowl with 2 beaten yolks, milk, and strained flour and mixed with MAP/_{z}. After, lemon zest and vanilla essence are added. After, the separated 2 egg whites are beaten until stiff and added slowly to the mixture. Lastly, baking powder is added. The mixture is left to rest for 5 minutes and baked for 45 to 60 minutes at 140° C.

### EXAMPLE 6

This example demonstrates the preparation of a baked food product, such as muffins, using MAP particles.

| Ingredients | Formula 1 | | Formula 2 | |
|---|---|---|---|---|
| Butter | 180 | g | 180 | g |
| Sugar | 150 | g | 150 | g |
| Eggs | 3 | u | 3 | u |
| Milk | 330 | mL | 330 | mL |
| Orange zest | 1 | u | 1 | u |
| Vanilla essence | 80 | g | 80 | g |
| Blueberries | 200 | g | 200 | g |
| Flour | 450 | g | 450 | g |
| Baking | 8 | g | 8 | g |
| Powder | | | | |
| MAP | 80 | g | 0 | g |

Preheat the oven to 200° C. Mix margarine and milk in a bowl at very low heat, until melted. Incorporate the eggs and the orange zest. Reserve. Put together in another bowl the dry ingredients, the MAP, and blueberries. Pour the milk on the dry ingredients and beat slowly, from the bottom upwards with a large rubber spatula. The mixture may be lumpy. The mixture is left to rest for 5 minutes and baked for 45 to 65 minutes at 140° C.

### EXAMPLE 7

This example demonstrates the preparation of a baked food product, such as muffins, using MAP/z particles.

| Ingredients | Formula 1 | | Formula 2 | |
|---|---|---|---|---|
| Butter | 180 | g | 180 | g |
| Sugar | 150 | g | 150 | g |
| Eggs | 3 | u | 3 | u |
| Milk | 330 | mL | 330 | mL |
| Orange zest | 1 | u | 1 | u |
| Vanilla essence | 80 | g | 80 | g |
| Blueberries | 200 | g | 200 | g |
| Flour | 450 | g | 450 | g |
| Baking Powders | 8 | g | 8 | g |
| MAP/z | 80 | g | 0 | g |

Preheat the oven at 200° C. Mix margarine and milk at very low heat until melted in a bowl. Incorporate the eggs and the orange zest. Reserve. Put together in another bowl the dry ingredients, the MAP/z, and blueberries. Pour the milk in the dry ingredients and beat slowly, from the bottom upwards with a large rubber spatula. The mixture may be lumpy. The mixture is left to rest for 5 minutes and baked for 45 to 65 minutes at 140° C.

### EXAMPLE 8

Preparation Of Hamburger With MAP.

| Ingredients | Formula 1 | | Formula 2 | | Formula 3 | | Formula 4 | |
|---|---|---|---|---|---|---|---|---|
| Hamburger base | 90 | g | 90 | g | 90 | g | 90 | g |
| Water | 150 | mL | 300 | mL | 380 | mL | 300 | mL |
| Coriander | 1 | g | 2 | g | 2.5 | g | 2 | g |
| Ciboulette | 5 | g | 8 | g | 8 | g | 8 | g |
| Beef meat | 0 | | 0 | | 50 | | 100 | |
| MAP | 50 | g | 100 | g | 100 | g | 0 | g |

All the formulations were prepared following the same procedure. The hamburger basis is dissolved in water, then the dry ingredients are added, stirring until a homogenous mixture is obtained. The mixture is baked for 15-20 minutes at medium heat in a conventional oven.

### EXAMPLE 9

This example demonstrates the preparation of a hamburger-type food product using MAP/z particles.

| Ingredients | Formula 1 | | Formula 2 | | Formula 3 | | Formula 4 | |
|---|---|---|---|---|---|---|---|---|
| Hamburger base | 90 | g | 90 | g | 90 | g | 90 | g |
| Water | 150 | mL | 300 | mL | 380 | mL | 300 | mL |
| Coriander | 1 | g | 2 | g | 2.5 | g | 2 | g |
| Ciboulette | 5 | g | 8 | g | 8 | g | 8 | g |
| Beef meat | 0 | | 0 | | 50 | | 100 | |
| MAP/z | 50 | g | 100 | g | 100 | g | 0 | g |

All the formulations are prepared following the same procedure. The hamburger base is dissolved in water, then the dry ingredients are added, stirring until a homogenous mixture is obtained. The mixture is baked for 15-20 minutes at medium heat in a conventional oven.

### EXAMPLE 10

This example demonstrates the evaluation of MAP-containing food products by a consumer panel.

Consumer Panel

The food of the examples were prepared in sufficient quantities for a consumer panel consisting of 8 people: four children between 4 and 10 years old and four adults between 20 and 70 years old.

The members of the panel were consulted about the features (e.g., odor, taste, texture, and appearance) of food products. The tasted foods were labeled with the number of the formulation. No information was provided about tastes and odors to be identified in the foods.

Confectionery Products

None of the panel members were able to detect differences between the different formulations of cakes or muffins. None of the panel members reported a taste or odor of fish, and none of the panel members were able to detect the different formulations with/without MAP and with/without MAP/z.

Hamburgers

None of the panel members reported a taste or odor of fish, and none of the panel members were able to detect the different formulations with/without MAP and with/without MAP/z.

None of the consumers were able to detect differences between the different formulations 3 and 4 of Examples 8 and 9. None of the panel members were able to detect the different formulations with/without MAP and with/without MAP/z.

In general, the panel members detected differences in the texture and taste of the hamburger between formulations 1 and 2 and formulations 3 and 4 in Examples 8 and 9, clearly due to the absence of meat in formulations 1 and 2. Surprisingly, none of the panel members could detect a fish-like odor in formulations 1 and 2 of Examples 8 and 9.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-20. (canceled)

21. A microencapsulated animal protein (MAP) particle comprising animal protein and gelatin, wherein the MAP particle is suitable for human consumption.

22. The MAP particle of claim 21, wherein the animal protein is animal protein concentrate (APC) comprising fish protein.

23. The MAP particle of claim 22, wherein the APC is in the form of particles.

24. The MAP particle of claim 23, wherein the APC particle size is homogenized by milling prior to microencapsulation.

25. The MAP particle of claim 24, wherein the APC particles are encapsulated in a gelatin matrix.

26. The MAP particle of claim 21, wherein the MAP particle is coated with zein.

27. The MAP particle of claim 21, wherein the MAP particle is about 100 μm to about 1000 μm in diameter

28. The MAP particle of claim 25, wherein the MAP particle is about 200 μm to about 600 μm in diameter

29. The MAP particle of claim 21, further comprising one or more of zein, a wax, an oil, a polymer, a polysiloxane, an additive, an aromatic substance, a colorant, a flavoring, a preservant, a flavor enhancer, and a sweetener.

30. The MAP particle of claim 22, wherein the APC further comprises an antioxidant selected from the group consisting of EDTA, a tocopherol, sodium ascorbate, L-ascorbic acid, BHA, BHT, lactic acid, citric acid, tartaric acid, and a phosphate.

31. The MAP particle of claim 21, wherein the MAP particle does not have a fishy taste or odor.

32. A food product comprising the MAP particle of claim 21.

33. The food product of claim 32, wherein the food product is a baked confectionary product.

34. The food product of claim 32, wherein the food product is a meat product.

35. The food product of claim 32, wherein the food product is selected from the group consisting of meat products such as sausage, ground meat, hamburger, or nuggets; soup; dairy products such as yogurt, pudding, cream, cheese, or ice cream; fruit juice; chocolate-based products such as chocolates bars; cereal bars; energy bars; cereals; flour-based products such as biscuits or bread; jams; sauces or condiments such as mayonnaise, ketchup, and tartar sauce; condiments; and food supplements.

36. A method of making the MAP particle of claim 21, comprising using spinning disk overcoating, fluid bed coating, and/or centrifugal co-extrusion to form the MAP particle.

37. A method of making the MAP particle of claim 26, comprising applying the zein using fluid bed coating.
